(19) United States
(12) Patent Application Publication
(10) Pub. No.: US 2012/0154118 A1
(43) Pub. Date: Jun. 21, 2012

(54) ELECTRONIC PAGER

(76) Inventor: Ching-Ming LIU, Banqiao City (TW)

(21) Appl. No.: 12/970,099

(22) Filed: Dec. 16, 2010

(51) Int. Cl. H04Q 1/30

(52) U.S. Cl. 340/7.1

(57) ABSTRACT

An electronic pager has a transmitting mechanism that can transmit searching signals after activation. The transmitting mechanism has a button electrically connected with the power supply, and a transmitter electrically connected with the button. A receiving mechanism is set in the remote controller to make a sound after receiving the searching signals. The receiving mechanism has a receiver and a buzzer electrically connected with the receiver.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to an electronic device, and more particularly to an electronic pager.

2. Description of Related Art Including Information Disclosed Under 37 CFR 1.97 and 37 CFR 1.98.

In order that the common household appliances or vehicles can be operated more conveniently for the benefit of the general public, a variety of remote controllers with additional operating functions have been developed to increase the added value of the products and meet the user demands.

Problems to be resolved:

The remote controller is generally configured in a space-saving way to be used by several users simultaneously for the purpose of portability and operational convenience. In such case, the final location of the remote controller is often forgotten by the users, or it is often covered by other articles, making it difficult to find. Notwithstanding the operational convenience of the remote controller, there still exist some inconvenience and shortcomings since the location of the remote controller are not fixed, such as TV remote controller.

### BRIEF SUMMARY OF THE INVENTION

For the purpose of resolving the aforementioned problems, the utility model is implemented by an electronic pager, which has a transmitting mechanism 1 that can transmit searching signals after activation. The transmitting mechanism 1 includes a button 11 electrically connected with the power supply 6, and a transmitter 12 electrically connected with the button 11. A receiving mechanism 2 is set in the remote controller 5 to make a sound after receiving the searching signals. The receiving mechanism 2 includes a receiver 21 and a buzzer 22 electrically connected with the receiver 21.

According to said electronic pager, said transmitting mechanism 1 can be set into either of the emitter 3 or object 4.

According to said electronic pager, said emitter 3 can be incorporated onto the surface of the object 4 via a fitting 31.

According to said electronic pager, said object 4 is configured into any of the following: TV set, Hi-Fi, DVD player, air conditioner, vehicle key and electric gate.

According to said electronic pager, a switch 13 is set at one side of said emitter 3 for controlling the power supply.

According to said electronic pager, said transmitter 12 is configured into either of the following: IR transmitter and wireless signal transmitter.

According to said electronic pager, said receiver 21 is configured into either of the following: IR receiver and wireless signal receiver.

According to said electronic pager, said remote controller 5 is configured into any of the following: remote controllers for TV, Hi-Fi, DVD player, automobile, locomotive, air conditioner and electric gate.

According to said electronic pager, said power supply 6 is configured into either of the following: battery and mains power supply.

### BRIEF DESCRIPTION OF THE SEVERAL VIEWS OF THE DRAWINGS

The following is a detailed description of the present invention based on the attached drawings:

FIG. 1 is a perspective view of the electronic pager of the present invention;

FIG. 2 is a circuit diagram of the electronic pager of the present invention;

FIG. 3 is a sectional view of the emitter of the present invention;

FIG. 4 is a sectional view of the remote controller of the present invention;

FIG. 5 is a schematic actuating view (1) of FIG. 1; and

FIG. 6 is a schematic actuating view (2) of FIG. 1.

### DETAILED DESCRIPTION OF THE INVENTION

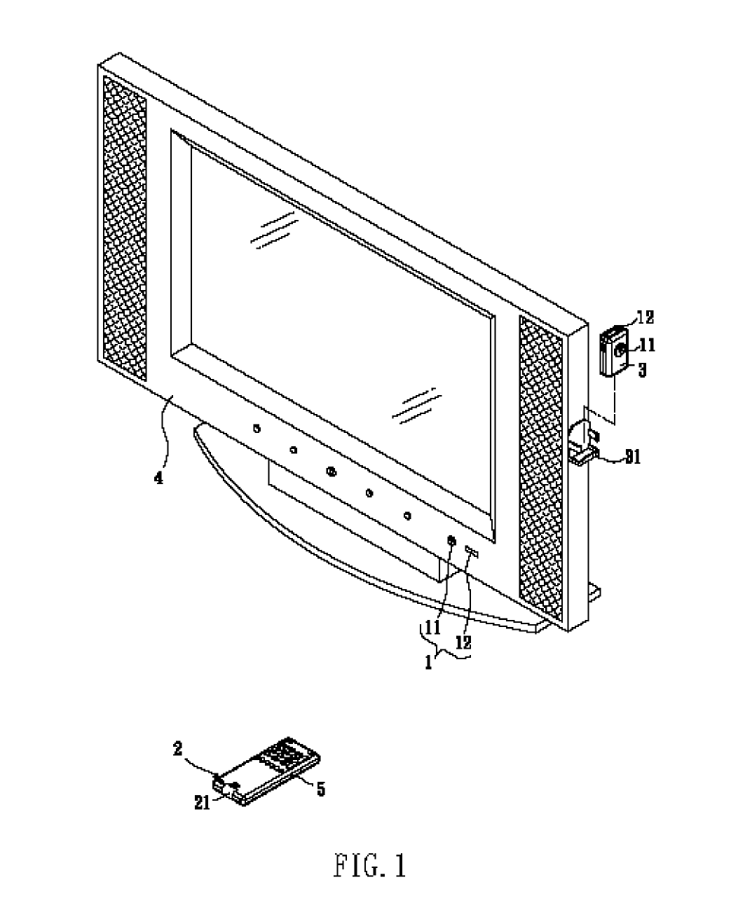

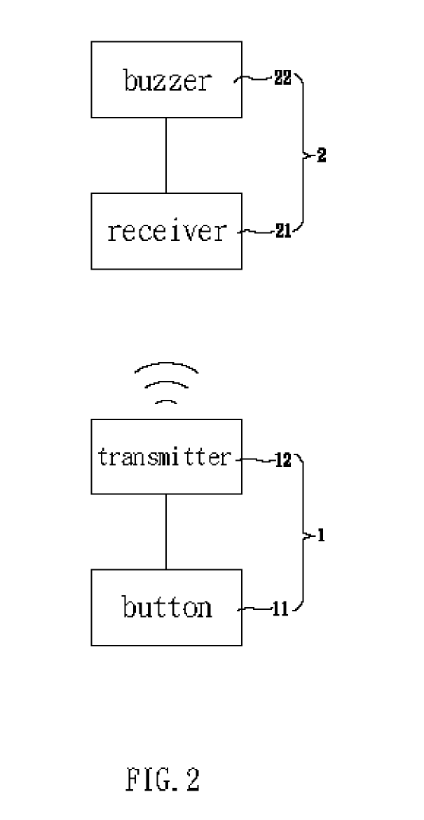

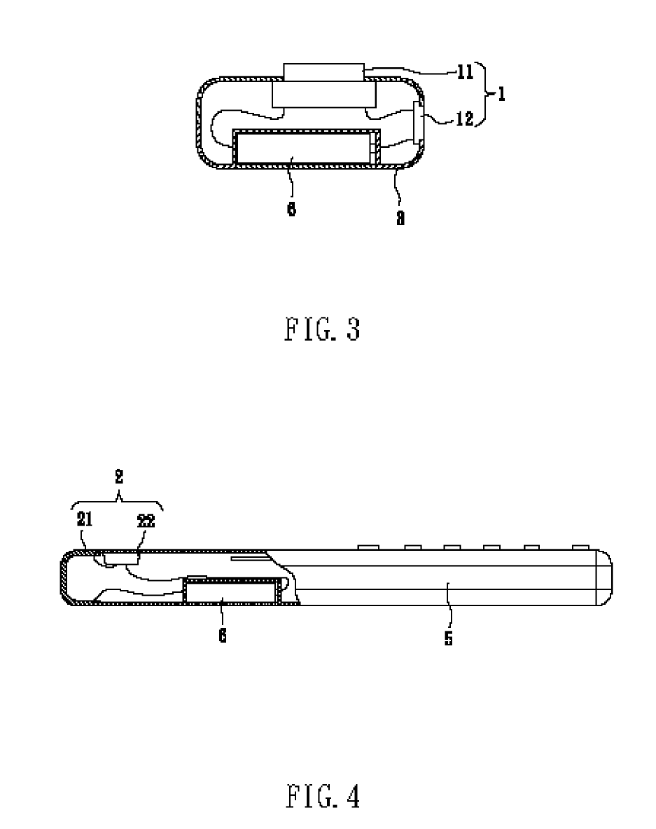

Referring to FIGS. 1-4, the electronic pager comprises a transmitting mechanism 1 that can transmit searching signals after activation. The transmitting mechanism 1 includes a button 11 electrically connected with the power supply 6, and a transmitter 12 electrically connected with the button 11. A receiving mechanism 2 is set in the remote controller 5 to make a sound after receiving the searching signals. The receiving mechanism 2 has a receiver 21 and a buzzer 22 electrically connected with the receiver 21.

The enhanced efficacy of the utility model is as follows:

When said transmitting mechanism 1 is set into the emitter 3, it can be hung at visible location enabling the users to access it easily if the required remote controller 5 is not found. Or when the transmitting mechanism 1 is built into the object 4, the users are only required to press the button 11 on the object 4 to identify the location of the remote controller 5 simultaneously.

A fitting 31 is set laterally onto said object 4 to hang the emitter 3, such that the emitter 3 can be located fixedly, enabling the user to access it easily for searching the remote controller 5.

Said transmitting mechanism 1 can be set into such an object 4 as TV set, Hi-Fi, DVD player, air conditioner, vehicle key and electric gate, thus turning itself into an electronic paging product.

Said switch 13 is set laterally onto the emitter 3 to control the on/off state of circuit, and reduce the dissipation of battery while preventing error contact when the emitter 3 is not required.

Said transmitter 12 and receiver 21 can be configured into a cost-saving IR transmitter and IR receiver, respectively.

Said transmitter 12 and receiver 21 are wireless signal transmitters and receivers, respectively, whereby the wireless signals can be transmitted or received, and acoustic signals can be given even if the remote controller 5 is covered by object.

Said remote controller 5 is configured into either of the space-saving and commonly used remote controllers 5 for TV, Hi-Fi, DVD player, automobile, locomotive, air conditioner and electric gate.

Said transmitting mechanism 1 is set into the object 4, and the main power supply is connected with the power supply 6 of the object 4. When said transmitting mechanism 1 is set into the emitter 3, the battery is used as the power supply 6.

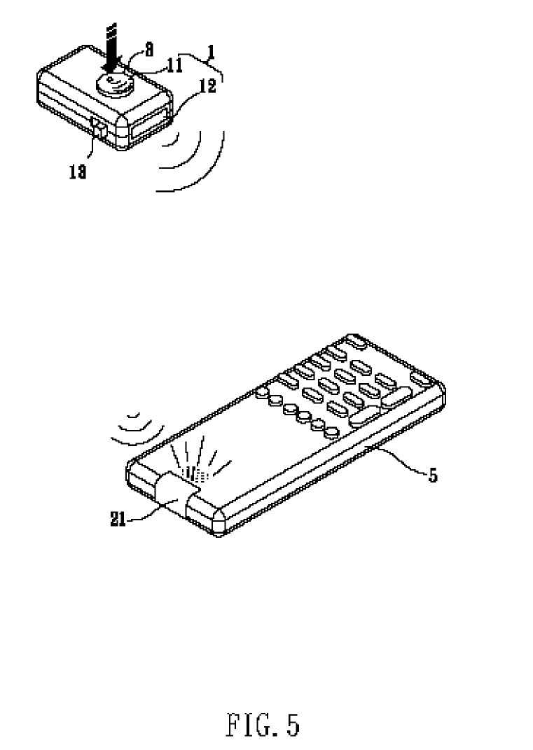

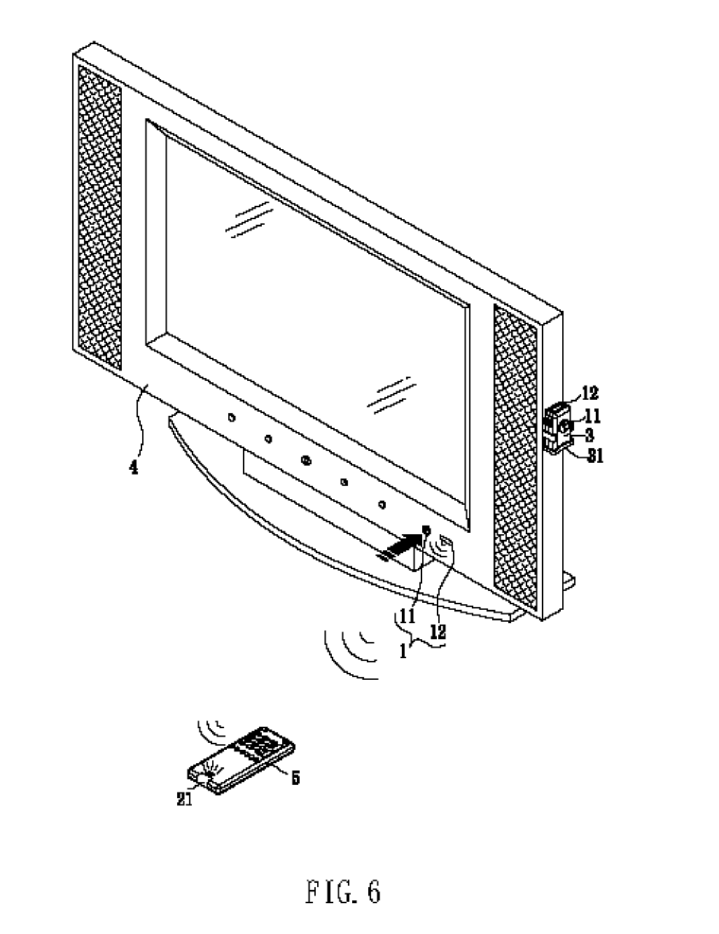

Referring to FIGS. 5 and 6, when a user presses the button 11 on the emitter 3 or object 4, the button 11 is energized such that the transmitter 12 can send searching signals, which are received by the receiver 21 and then sent to the buzzer 22. Next, the buzzer 22 gives an acoustic prompting to the user, enabling to find out the remote controller 5 quickly.

The above is a detailed description of the structure, technical features and efficacies of the present invention based on a typical preferred embodiment. However, it should be appreciated that the present invention is capable of a variety of embodiments and various modifications by those skilled in the art, and all such variations or equivalent changes shall be embraced within the scope of the following claims.

1. An electronic pager comprising:
a transmitting mechanism that can transmit searching signals after activation including a button electrically connected with a power supply, and a transmitter electrically connected with the button; and
a receiving mechanism set in a remote controller to make a sound after receiving the searching signals; the receiving mechanism has a receiver and a buzzer electrically connected with the receiver.

2. The structure defined in claim 1, wherein said transmitting mechanism is set into either of an emitter or an object.

3. The structure defined in claim 2, wherein said emitter can be incorporated onto the surface of the object via a fitting.

4. The structure defined in claim 2, wherein said object is configured into either of the following TV set, Hi-Fi, DVD player, air conditioner, vehicle key and electric gate.

5. The structure defined in claim 2, wherein a switch is set at one side of said emitter for controlling the power supply.

6. The structure defined in claim 1, wherein said transmitter is configured into either of the following: IR transmitter and wireless signal transmitter.

7. The structure defined in claim 1, wherein said receiver is configured into either of the following: IR receiver and wireless signal receiver.

8. The structure defined in claim 1, wherein said remote controller is configured into either of the following: remote controllers for TV, Hi-Fi, DVD player, automobile, locomotive, air conditioner and electric gate.

9. The structure defined in claim 1, wherein said power supply is configured into either of the following: battery and main power supply.
